(19) United States
(12) Patent Application Publication
(10) Pub. No.: US 2005/0014562 A1
(43) Pub. Date: Jan. 20, 2005

(54) Game management system for comprehensively managing histories in various games

(75) Inventor: Jun Fujimoto, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: ARUZE CORP.

(21) Appl. No.: 10/735,644

(22) Filed: Dec. 16, 2003

(30) Foreign Application Priority Data
Dec. 18, 2002 (JP) 2002-366923

(51) Int. Cl. A63F 9/24; A63F 13/00; G06F 17/00; G06F 19/00

(52) U.S. Cl. 463/42

(57) ABSTRACT

It is disclosed the game management system comprising: the bet board 32 having a plurality of bet areas allotted corresponding stop positions of the roulette ball 28 in the roulette wheel 26; the chip information recording device 34 in which information connecting with the chip 30 is recorded; the stop position detecting device 36 for detecting the stop position of the roulette ball 28 in the roulette wheel 26 and types of bet value in the roulette game; the bet information detecting device 38 for detecting the bet position and bet value of the chip 30 by reading the information connecting with the chip 30 recorded in the chip information recording device 34 when the chip 30 is betted on the bet area; the payout calculating device 62A for calculating payout in the roulette game based on the position of the roulette ball 28 in the roulette wheel 26, the bet position and bet value of the chip 30; and the PTS server 56 for managing the history of the roulette game based on the detected result detected by the stop position detecting device 36, the detected result detected by the bet information detecting device 38 and the payout calculated by the payout calculating device 62A.

### CROSS-REFERENCE TO THE RELATED APPLICATION(S)

This application is based upon and claims a priority from the prior Japanese Patent Application No. 2002-366923 filed on Dec. 18, 2002, the entire contents of which are incorporated herein by reference.

### BACKGROUND OF THE INVENTION

1. Field of the Invention

The present invention relates to a game management system for managing various games such as a roulette game in which a stop position of a roulette ball thrown in a roulette wheel is anticipated and chips are betted on bet areas of a bet board corresponding to the stop position of the roulette ball. In particular, the present invention relates to a game management system capable of comprehensively managing histories in various games and certainly detecting unfairness done in the games.

2. Description of Related Art

Generally speaking, in the game that a player anticipates a stop position of a roulette ball in a roulette wheel and bets chips to the anticipated position, the player anticipates the stop position of the roulette ball thrown in the roulette wheel by a dealer and bets chips to bet areas on a bet board, the bet areas corresponding to the anticipated stop position of the roulette ball. As the game arcade where the above roulette game is conducted, it is known a casino hotel.

On the other hand, as for management systems of hotel, there are previously proposed various management systems for managing hotel. For instance, a hotel service system is shown in Japanese Unexamined Publication No. 2000-357272. In this hotel service system, a house card (for example, an identification card in which an identification number for a guest is stored) is given to the guest when checking in the hotel, and the guest can receive various services in the facilities in the hotel by using the house card. For instance, in a restaurant or a bar lounge in the hotel, the identification number of the house card is read out and a charge sum to be paid is transmitted to and accumulated in a hotel server based on the identification number. And a total charge sum to be paid is displayed on a terminal device installed at a hotel front desk by verifying the identification number recorded in the house card when the guest checks out. Further, the guest may use the house card when using transportation out of the hotel while staying at the hotel by connecting the hotel server to the transportation through a network.

By the way, in the previous casino hotel, it is general that a gaming charge in the casino is set as a separate account. Therefore, the guest cannot settle accounts of the gaming charge together with the other charge sum by using the house card when checking out the hotel. In this case, the previous hotel management system mentioned above cannot record types of games played in and sum consumed in the casino and the other information in a history from check-in till check-out of the guest, therefore it is very difficult to spread out highly individualized services.

Further, as mentioned, since the guest has to pay out the gaming charge in cash in the casino as a rule and cannot use credit service, there may occur a problem that the guest cannot pay the gaming charge in a case that the guest is beside himself with the game and endlessly enjoys the game.

Further, it often occurs counterfeit act in which the roulette ball or the chip is forged and the counterfeit roulette ball or the chip is used in the game, or unfair act in which the player and the dealer conspire to do unfairness.

### SUMMARY OF THE INVENTION

The present invention is done to accomplish the above problems and has a object to provide a game management system in which histories of various games can be comprehensively managed and unfairness done in games can be easily detected.

To accomplish the above problems, according to one aspect of the present invention, it is provided a game management system for managing various games that utilizes a roulette wheel with a plurality of pockets formed therein and a bet board having a plurality of bet areas formed corresponding to the pockets of the roulette wheel and that utilizes a chip betted on at least one of the bet areas while anticipating on which one of the pockets a roulette ball thrown in the roulette wheel stops,
the game management system comprising:
first detecting means arranged on the roulette wheel for detecting a position of the pocket where the roulette ball stops on the roulette wheel, and types of value in the game corresponding to the pocket;
second detecting means arranged on the bet board for detecting a bet position and bet value of the chip when the chip is betted on the bet area;
payout calculating means for calculating a payout in the game based on the position of the pocket where the roulette ball stops and the value in the game detected by the first detecting means, the bet position and the bet value of the chip detected by the second detecting means; and
managing means for managing a history of the game based on a result detected by the first detecting means, a result detected by the second detecting means and the payout calculated by the payout calculating means.

In the above game management system, it is detected by the first detecting means both the position of the pocket where the roulette ball stops and types of value in the game corresponding to the detected pocket, and it is detected by the second detecting means both the bet position and the bet value of the chip. And the payout calculating means calculates the payout in the game based on the position of the pocket where the roulette ball stops and the value in the game detected by the first detecting means, the bet position and the bet value of the chip detected by the second detecting means. Further, the managing means manages the history of the game based on the result detected by the first detecting means, the result detected by the second detecting means and the payout calculated by the allocation calculating means. Thereby, it can realize the game management system by which the history of the game can be comprehensively managed in the game that the stop position of the roulette ball thrown in the roulette wheel is anticipated and the chip is betted on the bet area corresponding to the stop position of the roulette ball.

Thus, in the game management system, the position of the roulette ball and the bet position of the chip are always checked by the first detecting means and the second detecting means, therefore it can be immediately determined that counterfeit roulette balls or chips are used in the game when the counterfeit roulette balls or chips are used during the game. As a result, the game management system is very useful to find unfair act in the game.

Further, according to another aspect of the present invention, it is provided a game system for conducting various games that a roulette wheel with a plurality of pockets formed therein and a bet board having a plurality of bet areas formed corresponding to the pockets of the roulette wheel are utilized and a chip is betted on at least one of the bet areas while anticipating on which one of the pockets a roulette ball thrown in the roulette wheel stops,
the game system comprising:
a first detecting device arranged on the roulette wheel for detecting a position of the pocket where the roulette ball stops on the roulette wheel and types of value in the game corresponding to the pocket;
a second detecting device arranged on the bet board for detecting a bet position and bet value of the chip when the chip is betted on the bet area; and
a payout calculating device for calculating a payout in the game based on the position of the pocket where the roulette ball stops and the value in the game detected by the first detecting device, the bet position and the bet value of the chip detected by the second detecting device.

In the above game system, it is detected by the first detecting device both the position of the pocket where the roulette ball stops and types of value in the game corresponding to the detected pocket, and it is detected by the second detecting device both the bet position and the bet value of the chip. And the payout calculating device calculates the payout in the game based on the position of the pocket where the roulette ball stops and the value in the game detected by the first detecting device, the bet position and the bet value of the chip detected by the second detecting device. Therefore, it can be automatically managed a series of game treatment from betting of the chip on the bet board to calculation of the payout in the game, thereby the game can be smoothly advanced.

In addition, according to further another aspect of the present invention, it is provided a game management system for managing various games conducted in game arcades installed in a casino arranged in a hotel,
the game management system comprises:
an identification card issuing device installed in the hotel for issuing an identification card which is issued to a guest of the hotel when checking in to identify the guest, the guest being able to utilize various services provided in the hotel by using the identification card;
a reading device installed in the casino for reading information identifying the guest recorded in the identification card issued by the identification card issuing device; and
a managing device for managing a history of the game conducted in the game arcades corresponding to the information identifying the guest read by the reading device.

In the above game management system, the identification card is issued to the guest of the hotel by the identification card issuing device installed in the hotel, the guest being able to utilize various services provided in the hotel by using the identification card. And the information identifying the guest recorded in the identification card is read out by the reading device installed in the casino. Further, the managing device manages the history of the game conducted in the game arcades corresponding to the information identifying the guest read by the reading device. Therefore, the guest can utilize not only various services provided in the hotel but also the game arcades in the casino by using the identification card which is issued to the guest when checking in the hotel. Thereby, it can spread out highly individualized services which cannot be done in the previous hotel system. In particular, though, up to this time, the gaming charge in the casino is set as a separate account and the casino user has to manage money for game himself or herself, thus it is very troublesome and inconvenient for the guest, the casino user can pay out in one lump by using the identification card when checking out the hotel, therefore burden of the casino user can be reduced.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is an explanatory view for showing a casino/hotel construction in which a game management system according to the embodiment of the present invention is constructed.

FIG. 2 is an explanatory view for schematically showing a roulette wheel and a bet board, FIG. 2(a) is a plan view showing a construction of the roulette wheel, FIG. 2(b) is a plan view showing a construction of the bet board and FIG. 2(c) is an explanatory view showing a basic construction of a detecting device for detecting a stop position of a roulette ball and a detecting device for detecting bet information.

FIG. 3 is an explanatory view schematically showing histories of roulette games, and

FIG. 4 is an explanatory view schematically showing histories of roulette games, each history being managed corresponding to each player.

### DETAILED DESCRIPTION OF THE PREFERRED EMBODIMENTS

Hereinafter, a game management system according to the embodiment of the present invention will be described with reference to the drawings.

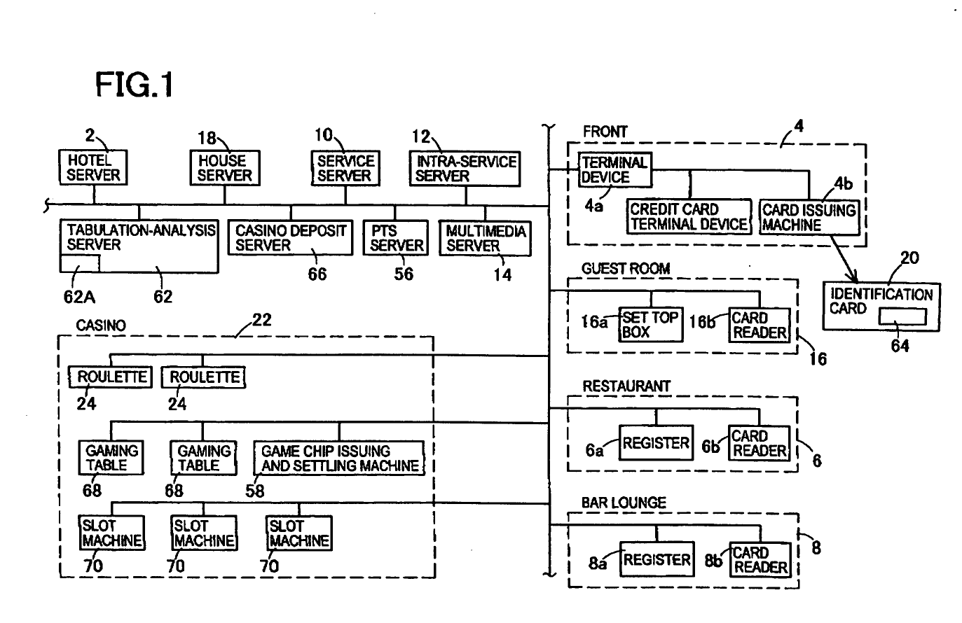

In FIG. 1, a casino/hotel construction, in which the game management system of the embodiment is constructed, is shown.

In a hotel server 2, it is constructed various functions for comprehensively managing a terminal device 4a installed on a front desk 4 and registers 6a, 8a installed in a restaurant 6) and a bar lounge 8. And in a service server 10, it is constructed various functions for reserving various shows or events provided in the hotel and issuing tickets therefor. Further, in an intra-service server 12, it is constructed functions for controlling an intranet constructed in the hotel, and in a multi-media server 14, it is constructed functions corresponding to video-on-demand and game-on-demand utilized when the guest enjoys video service or game service in a guest room 16 by using a set top box 16a.

A house card server 18 has various functions for managing an identification card 20 utilizable for the house card (the identification card 20 capable of identifying a guest who stays in the hotel) and an individual account of the guest. The identification card (house card) 20 for identifying the guest checking in the casino/hotel is issued to the guest by a card issuing machine 4b installed in the front desk 4. Thereafter, the guest can use all facilities in the casino/hotel by submitting the identification card 20 at each of the facilities and passing check of the identification card 20.

For example, in a case that the guest uses the restaurant 6 or the bar lounge 8, or video service or game service in the guest room 16, the identification card 20 is read by the card reader 6b, 8b, 16b, thereby charge sum to be paid is accumulated in the hotel server 2. And total charge sum to be paid is displayed on the terminal device 4a when the guest checks out. That is to say, the identification card 20 can Link with various management systems other than the game management system (mentioned later), therefore the identification card 20 functions as at least a credit card used for paying money when the guest buys goods or eats and drinks.

Here, a tabulation-analysis server 62, a casino deposit server 66 and a player tracking system (PTS) server 56 will be described hereinafter.

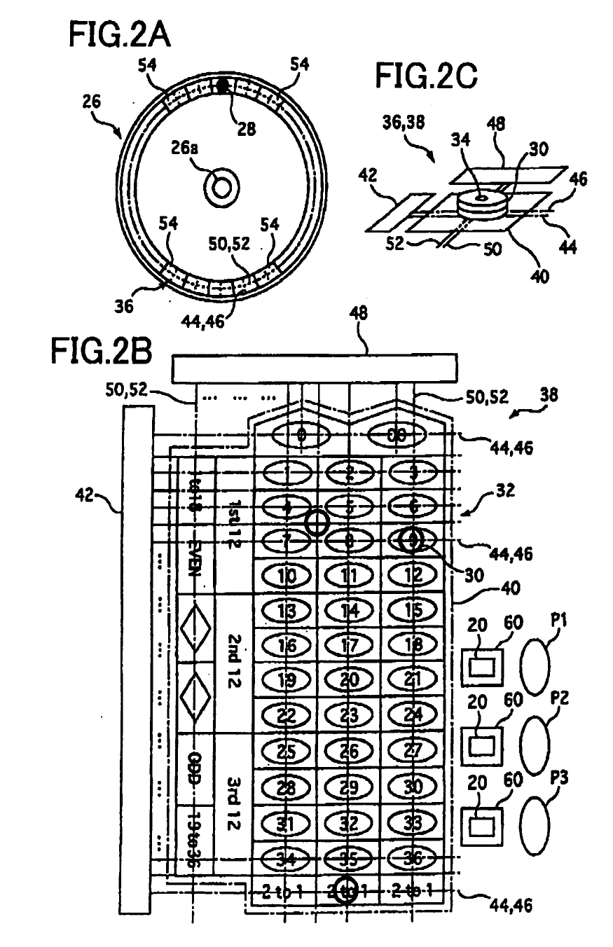

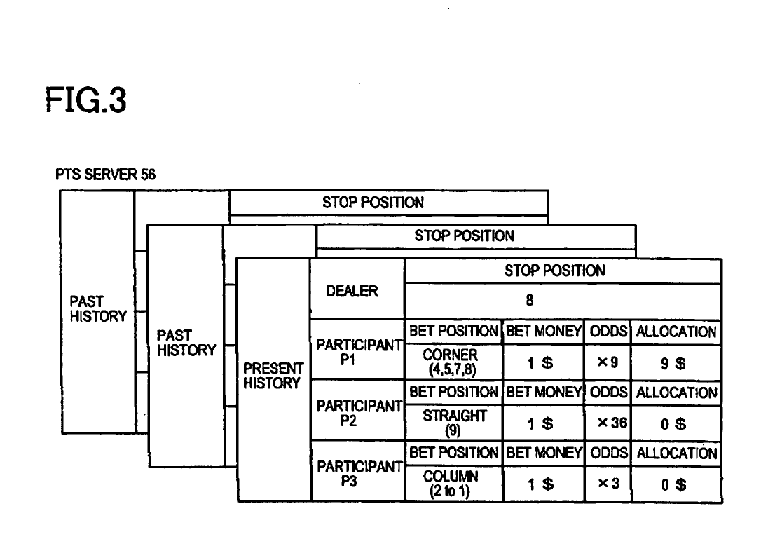

In the above mentioned game management system constructed in the casino/hotel, it is constructed various functions for managing various games conducted in the casino 22. Hereinafter, as an example of the game management system, the game management system for the roulette 24 will be described. In this game management system, various roulette games are conducted. In the roulette games, the stop position of the roulette ball 28 thrown in the roulette wheel 26 is anticipated and chips 30 are betted on bet area (8) of the bet board 32 corresponding to the stop position (see FIGS. 2 and 3).

In the game management system, as shown in FIGS. 2(a) to 2(c), there are provided the bet board 32, a chip information recording device 34 embedded in each chip 30, a stop position detecting device 36 for detecting the stop position of the roulette ball 28, a bet information detecting device 38 provided in the bet board 32 and a payout calculating device 62A.

Here, in the bet board 32, plural bet areas (for example, each spot divided by numerals such as 0, 00, 1, 2, . . . , 35, 36) corresponding to the stop positions at each of which the roulette ball 28 in the roulette wheel 26 may stop, are formed and the chips 30 are betted on the bet areas.

The chip information recording device 34 is embedded in each chip 30 and the information connecting with the chip 30 is recorded.

The stop position detecting device 36 is provided on the roulette wheel 26 and detects the stop position of the roulette ball 28 in the roulette wheel 26 and types of value in the roulette games.

The bet information detecting device 38 is provided on the bet board 32 and detects the bet position on the bet board 32 and bet value corresponding to the bet position by reading the chip information recorded in the chip information recording device 34 in the chip 30 when the chip 30 is betted on the bet areas.

The payout calculating device 62A calculates the payout in the roulette game based on the stop position of the roulette ball 28 in the roulette wheel 26, the bet position of the chip 30 and the bet value corresponding to the bet position.

The chip information recording device 34 comprises a subminiature wireless ID tag embedded in each chip 30. The information connecting with the chip 30 includes: a specific number (the number identifying each chip 30) for identifying the chip 30, value (for example, 1 dollar, 5 dollars, 10 dollars), color of the chip 30 and places, i.e., the hotel including the casino 22 where the chips 30 can be used.

Both the stop position detecting device 36 and the bet information detecting device 38 have basically same construction. In particular, as shown in FIG. 2(c), both devices 36 and 38 are constructed from an ID reading device and a measuring device 40. In the ID reading device, there are provided an X-axis transmitting antenna 44 and an X-axis receiving antenna 46 both of which are extended parallel with each other from an X-axis scanning driver 42, and a Y-axis transmitting antenna 50 and a Y-axis receiving antenna 52 both of which are extended parallel with each other from a Y-axis scanning driver 48 and arranged so as to cross the X-axis transmitting antenna 44 and the X-axis receiving antenna 46 at right angle.

In the above ID reading device, in a case that the scanning wave is sent from the X-axis transmitting antenna 44 and the Y-axis transmitting antenna 50 under the state that the chip 30 is betted on the bet area of the bet board 32, the electric wave for reading is risen near the cross point of the antennae 44, 50. The electric wave for reading is received by the X-axis receiving antenna 46 and the Y-axis receiving antenna 52. At that time, if the chip 30 is betted (positioned) near the cross point, impedance is changed near the cross point based on that the chip 30 acts as dielectric substance, thereby wave receiving state in both the receiving antennae 46, 52 is changed. By detecting this changing state in wave receiving, it is detected whether the chip 30 exists or not. At the same time, the signal from the chip information recording device (the subminiature wireless ID tag) 34 is received by the X-axis receiving antenna 46 and the Y-axis receiving antenna 52, thereby the chip information such as the value of the chip 30 (1 dollar, 5 dollars, 10 dollars) and the specific number (the number identifying each chip 30) is read out.

Here, it will be described a case that the ID reading device mentioned above is applied to the stop position detecting device 36. As shown in FIG. 2(a), the roulette wheel 26 comprises a body of rotation with a circular plate-like shape. And in the roulette wheel 26, pockets 54 are concentrically formed from a rotational axis 26a. Total number of the pockets 54 is 38 though a part of the pockets 54 is shown in FIG. 2(a). In each pocket 54, a numeral is printed thereon, the numeral corresponding to one of plural bet areas each of which is allotted on the bet board 32 and comprises, for example, a spot area divided by a numeral such as 0, 00, 1, 2, . . . , 35, 36.

The stop position detecting device 36 of the roulette ball 28 is arranged in each pocket 54, and when the roulette ball 28 enters in the pocket 54, the roulette ball 28 positions on the cross point in the ID reading device mentioned above. At that time, the above mentioned electric wave for reading is in a rising state and when the roulette ball 28 is positioned near the cross point, the wave receiving state only in the above pocket 54 is changed. As a result, it can be detected the position in the roulette wheel 26 (the pocket 54) in which the roulette ball 28 enters. At that time, the detected data are transmitted to the PTS (Player Tracking System) server 56 and the history thereof is comprehensively managed, as shown in FIG. 3.

Further, it will be described the case that the ID reading device is applied to the bet information detecting device 38. As shown in FIG. 2(b), a plurality of bet areas are formed in the bet board 32. And there are provided a pair of the X-axis transmitting antenna 44 and the X-axis receiving antenna 46 and a pair of the Y-axis transmitting antenna 50 and the Y-axis receiving antenna 52, so as to form the cross point in each bet area. When the chip 30 is betted on the bet area (“9”: straight) in the above constructed bet board 32 as shown in FIG. 2(b), the betted chip 30 is positioned near the cross point of the ID reading device. Here, since the electric wave for reading is in a rising state, the wave receiving state only in the bet area is changed based on that the chip 30 is positioned near the cross point. As a result, it can be detected the bet area of the bet board 32 on which the chip 30 is betted. At that time, the detected data are transmitted to the PTS server 56 and the history thereof is comprehensively managed, as shown in FIG. 3.

The measuring device 40 is arranged so as to cover the bet area of the bet board 32 as shown in FIG. 2(c). It is utilizable, for example, an electronic measuring device such as a semiconductor pressure sensor and the like, as the measuring device 40. In the measuring device 40, unit weight corresponding to one chip 30 is recorded, and the number of the chips 30 betted on the bet board 32 can be calculated by dividing total weight of the chips 30 betted on the bet board 32 by the unit weight of one chip 30. In this case, the PTS server 56 compares the calculated number of the chips 30 and the detected result by the bet information detecting device 38, and when the calculated number of the chips 30 does not coincide with the detected result by the bet information detecting device 38, the PTS server 56 determines that counterfeit chips are used and alarms it to a dealer, for example.

Here, in the roulette ball 28, it is embedded an identification information recording device (not shown) in which identification information for identifying the roulette ball 28 is recorded. The identification information recording device comprises a subminiature wireless ID tag, which is embedded in the roulette ball 28. The identification information includes various information such as information indicating origin of the roulette ball 28, information indicating places (casino 22) where the roulette ball 28 can be used, information indicating kinds of the roulette ball 28 and the like.

The identification information recorded in the identification information recording device can be read by the ID reading device comprising the stop position detecting device 36. And the PTS server 56 can determine based on the read out information whether the roulette ball 28 is utilizable or not. Therefore, the game management system is very useful to prevent unfair and infringing act that the counterfeit roulette ball 28 is used.

Hereinafter, it will be described how the roulette game is conducted in the above mentioned game management system. If persons P1, P2 and P3 desire to play the roulette game, they enter in the casino 22 (see FIG. 1) with their identification cards 20. At first, they obtain the chips 30 at the chip issuing and settling machine 58. And the identification card 20 is set on the reading device 60. At that time, the contents of the identification card 20 is read out by the reading device 60, thereby each person P1, P2 or P3 is identified and recognized as a game participant. Data read out and identified by the reading device 60 are transmitted to the PTS server 56 and persons P1, P2 and P3 are entered as the game participants in the present game as shown in FIG. 3. Here, reading method of the reading device 60 can be voluntarily set according to recording method in the identification card 20. For instance, if the recording method in the identification card 20 is magnetic recording method, the reading device 60 adopts magnetically reading method. Similarly, if the recording method in the identification card 20 is optical recording method, the reading device 60 adopts optically reading method.

At the start of the roulette game, the dealer rotates the roulette wheel 26 and enters the roulette ball 28 therein. While the roulette wheel 26 is rotating and the roulette ball 28 is moving in the roulette wheel 26, the participants P1, P2, P3 bet the chips 30 on the bet areas of the bet board 32. Here, for example, it is supposed that the participant P1 bets at the corner (4, 5, 7, 8), the participant P2 bets on the straight (9) and the participant P3 bets on the column (2 to 1), as shown in FIG. 3. At that time, the bet positions and the bet value (1 dollar, 5 dollars or 10 dollars: betted money) are detected by the bet information detecting device 38, and the detected result is transmitted to the PTS server 56. The PTS server 56 comprehensively manages the history of bet information.

In the meantime, rotation of the roulette wheel 26 gradually slows and the roulette ball 28 stops in one of the pockets 54. If the numeral of the pocket 54 in which the roulette ball 28 enters is “8”, it is detected by the stop position detecting device 36 the numeral “8” which corresponds to the stop position of the roulette ball 28, and the result about the stop position is transmitted to the PTS server 56. The PTS server 56 comprehensively manages the history of the stop position.

It is constructed the payout calculating device 62A in the tabulation-analysis server 62, and the payout calculating device 62A calculates the payout in the roulette game based on the stop position of the roulette ball 28 (the numeral “8” corresponding to the stop position) in the roulette wheel 26 and both the bet position of the chip 30 and the bet value (betted money), as shown in FIG. 3.

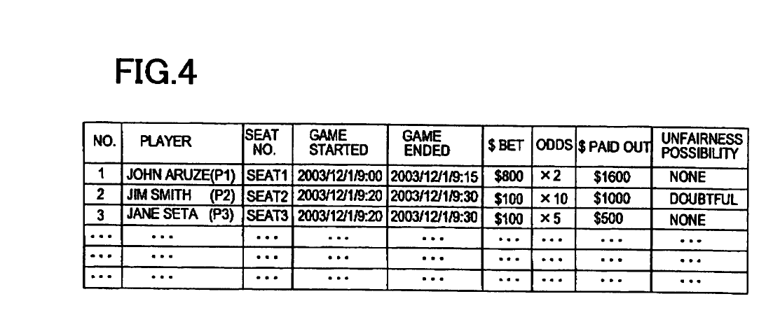

In the PTS server 56, as shown in FIG. 4, it is constructed several items such as a seat No., a time that game is started, a time that game is ended, a betted money, odds, money paid out and unfairness possibility, corresponding to each player participating in the game (the participant John Aruze (P1), the participant Jim Smith (P2), the participant Jane Seta (P3)) identified by an ID number which is read from the identification card 20 by the reading device 60 arranged near the bet board 32.

For example, concretely describing based on FIG. 4, it can be understood that the participant John Aruze sat down on the seat 1 and participated in the game from 9:00, Dec. 1, 2003 till 9:15, and during the game his bet money was $800, the odds was ×2 and the paid out money was $1,600. In this case, considering that the bet money was $800 and the odds was ×2, there is no doubt in the roulette game. Thus, it is determined that unfairness possibility is none.

And, similarly to the above, it can be understood that the participant Jim Smith sat on the seat 2 and participated in the game from 9:20, Dec. 1, 2003 till 9:30, and during the game his bet money was $100, the odds was ×10 and the paid out money was $1,000. In this case, considering that the bet money was $100 and the odds was ×10, the paid out money was considerably large in comparison with the bet money, therefore a difference between the paid out money and the bet money was considerably large. At this point of view, there is generally doubt in the roulette game. As a result, it is judged that unfairness possibility is doubtful.

Further, similarly to the above, it can be understood that the participant Jane Seta sat down on the seat 3 and participated in the game from 9:20, Dec. 1, 2003 till 9:30, and during the game her bet money was $100, the odds was ×5 and the paid out money was $500. In this case, considering that the bet money was $100 and the odds was ×5, there is no doubt in the roulette game. Thus, it is judged that unfairness possibility is none.

As mentioned above, in the PTS server 56, the entire history of the game is managed from the start of the game till the end of the game based on the seat No., the start time of the game, the end time of the game, the bet money, the odds and the paid out money, every participant identified by the ID number read out from the identification card 20 through the reading device 60, and it is judged whether unfairness exists or not. Therefore, it can be realized the game management system useful for preventing unfair gaming or unfair operation.

In the PNS server 56, the position of the roulette ball 28 and the bet position of the chip 30 are usually checked by the stop position detecting device 36 and the bet information detecting device 38. Therefore, when a counterfeit roulette ball or a counterfeit chip is used during the roulette game, it can be immediately determined that the counterfeit roulette ball or chip is used. Further, in a case that the dealer and the participants P1, P2, P3 conspire to do unfair act, it can be correctly grasped the time at which unfair act is done and the flow of the roulette ball 28 and the chip 30 in the roulette game, according to the history comprehensively managed in the PTS server 56.

Further, in the above game management system, the guest can use all hotel facilities by using the identification card (house card) 20 which is issued when checking in the hotel. Thus, it can be spread highly individualized services.

Especially, up to this time, the gaming charge in the casino is set as a separate account and the casino user has to manage money for game himself or herself, thus it is very troublesome and inconvenient for the guest. However, in the above game management system, the casino user can pay out in one lump by using the identification card 20 when checking out the hotel, therefore burden of the casino user can be reduced.

And it can be avoided the problem that the casino user is beside himself with the game and endlessly enjoys the game, by utilizing the deposit function in the identification card 20, thus the casino user can avoid to unwillingly get more loss than wins. As a result, the casino user can relievedly enjoy the roulette game.

Here, in the embodiment mentioned, though the chips 30 are directly betted on the bet board 32, since it is formed in the identification card 20 a deposit reference part 64 (see FIG. 1) by which the guest can refer the deposit amount deposited by the guest, the guest may enjoy the roulette game according to the referred result by the deposit reference part 64, instead of the chips 30. In this case, the participants P1, P2, P3 can bet desirable bet money by an input device (for example, ten keys, not shown) positioned near the participants P1, P2, and P3. Similarly to the case of the chips 30, the betted money is serially registered in the PTS server 56 and comprehensively managed by the tabulation-analysis server 62. Here, increase and decrease of the deposit amount in the casino 22 is comprehensively managed by the casino deposit server 66 (see FIG. 1), therefore it can be conducted without cash renewal treatment of the deposit balance according to score of the game result and paying treatment in a case that the participants desire to set an additional deposit.

Needless to say, the identification card 20 can be used for the other gaming machines such as the slot machines and the gaming history thereof can be comprehensively managed by the PTS server 56 in which such history is registered according to the same manner as that shown in FIG. 3.

1. A game management system for managing various games that utilizes a roulette wheel with a plurality of pockets formed therein and a bet board having a plurality of bet areas formed corresponding to the pockets of the roulette wheel and that utilizes a chip betted on at least one of the bet areas while anticipating on which one of the pockets a roulette ball thrown in the roulette wheel stops,
the game management system comprising:
first detecting means arranged on the roulette wheel for detecting a position of the pocket where the roulette ball stops on the roulette wheel, and types of value in the game corresponding to the pocket;
second detecting means arranged on the bet board for detecting a bet position and bet value of the chip when the chip is betted on the bet area;
payout calculating means for calculating a payout in the game based on the position of the pocket where the roulette ball stops and the value in the game detected by the first detecting means, the bet position and the bet value of the chip detected by the second detecting means; and
managing means for managing a history of the game based on a result detected by the first detecting means, a result detected by the second detecting means and the payout calculated by the payout calculating means.

2. The game management system according to claim 1, further comprising:
identification card issuing means for issuing an identification card identifying a participant participating in the various games; and
reading means for reading information identifying the participant recorded in the identification card issued by the identification card issuing means;
wherein the managing means manages the history of the game corresponding to the information identifying the participant read by the reading means based on the result detected by the first detecting means, the result detected by the second detecting means and the payout calculated by the payout calculating means.

3. The game management system according to claim 2, wherein the identification card has a deposit reference part for referring a deposit deposited by the participant therein, and
wherein the participant continues the game according to the deposit read from the deposit reference part.

4. The game management system according to claim 1, wherein the first detecting means comprises:
a first transmitting antenna and a first receiving antenna both of which are arranged parallel with each other on each of the pockets;
a first scanning driver connected to both the first transmitting antenna and the first receiving antenna;
a second transmitting antenna and a second receiving antenna both of which are arranged parallel with each other on each of the pockets, so as to cross the first transmitting antenna and the first receiving antenna at right angle; and
a second scanning driver connected to both the second transmitting antenna and the second receiving antenna.

5. The game management system according to claim 4, wherein the first detecting means detects the pocket where the roulette ball stops by detecting a change of receiving state in electric wave detected by the first receiving antenna and the second receiving antenna, when scanning electric wave is sent from the first transmitting antenna by the first scanning driver and is sent from the second transmitting antenna by the second scanning driver.

6. The game management system according to claim 5, further comprising:
identification information recording means arranged in the roulette ball, identification information identifying the roulette ball being recorded in the identification information recording means;
wherein the identification information includes at least information in connection with origin of the roulette ball, a place where the roulette ball can be utilized and a kind of the roulette ball.

7. The game management system according to claim 6, wherein the identification information recording means comprises a subminiature wireless ID tag embedded in the roulette ball, and
wherein the identification information recorded in the subminiature wireless ID tag is read by the first detecting means.

8. The game management system according to claim 7, wherein it is determined whether the roulette ball can be utilized in the game or not, based on the identification information read by the first detecting means.

9. The game management system according to claim 1, wherein the second detecting means comprises:
a first transmitting antenna and a first receiving antenna both of which are arranged parallel with each other on each of the bet areas of the bet board;
a first scanning driver connected to both the first transmitting antenna and the first receiving antenna;
a second transmitting antenna and a second receiving antenna both of which are arranged parallel with each other on each of the bet areas, so as to cross the first transmitting antenna and the first receiving antenna at right angle; and
a second scanning driver connected to both of the second transmitting antenna and the second receiving antenna.

10. The game management system according to claim 9, wherein the second detecting means detects the bet area where the chip is betted by detecting a change of receiving state in electric wave received by the first receiving antenna and the second receiving antenna, when scanning electric wave is sent from the first transmitting antenna by the first scanning driver and is sent from the second transmitting antenna by the second scanning driver.

11. The game management system according to claim 10, further comprising:
chip information recording means arranged in the chip, chip information being recorded in the chip information recording means;
wherein the chip information includes at least information in connection with a specific number for identifying the chip, bet value and a place where the chip is utilized.

12. The game management system according to claim 11, wherein the chip information recording means comprises a subminiature wireless ID tag embedded in the chip, and
wherein the chip information recorded in the subminiature wireless ID tag is read by the second detecting means.

13. The game management system according to claim 9, further comprising:
a measuring means arranged corresponding to each of the bet areas in the bet board;
wherein the measuring means calculates a number of the chips based on unit weight of one chip.

14. The game management system according to claim 13, wherein the measuring means comprises a semiconductor pressure sensor.

15. The game management system according to claim 13, wherein it is determined whether the chip is forged or not by comparing the calculated number of the chips by the measuring means with the result detected by the second detecting means.

16. The game management system according to claim 15, wherein it is determined that the chip is forged when the calculated number of the chips does not coincide with the result detected by the second detecting means.

17. A game system for conducting various games that a roulette wheel with a plurality of pockets formed therein and a bet board having a plurality of bet areas formed corresponding to the pockets of the roulette wheel are utilized and a chip is betted on at least one of the bet areas while anticipating on which one of the pockets a roulette ball thrown in the roulette wheel stops,
the game system comprising:
a first detecting device arranged on the roulette wheel for detecting a position of the pocket where the roulette ball stops on the roulette wheel and types of value in the game corresponding to the pocket;
a second detecting device arranged on the bet board for detecting a bet position and bet value of the chip when the chip is betted on the bet area; and
a payout calculating device for calculating a payout in the game based on the position of the pocket where the roulette ball stops and the value in the game detected by the first detecting device, the bet position and the bet value of the chip detected by the second detecting device.

18. A game management system for managing various games conducted in game arcades installed in a casino arranged in a hotel,
the game management system comprises:
an identification card issuing device installed in the hotel for issuing an identification card which is issued to a guest of the hotel when checking in to identify the guest, the guest being able to utilize various services provided in the hotel by using the identification card;
a reading device installed in the casino for reading information identifying the guest recorded in the identification card issued by the identification card issuing device; and
a managing device for managing a history of the game conducted in the game arcades corresponding to the information identifying the guest read by the reading device.

19. The game management system according to claim 18, wherein the identification card has a deposit reference part for referring a deposit deposited by the guest of the hotel therein, and
wherein the guest continues the game according to the deposit read from the deposit reference part.

20. The game management system according to claim 18, further comprising:
a game medium issuing device for issuing a game medium utilizable in the game arcades by using the identification card.
